(19) United States
(12) Patent Application Publication
(10) Pub. No.: US 2020/0362183 A1
(43) Pub. Date: Nov. 19, 2020

(54) GRAPHENE PRIMER FOR FIBER FILLED POLYMER SUBSTRATES

(71) Applicant: Magna Exteriors Inc., Concord (CA)

(72) Inventors: Ganesh SINGH, Troy, MI (US); Benjamin James BARBER, Rochester, MI (US); Alexis BALTAZAR-y-JIMENEZ, Concord (CA)

(73) Assignee: Magna Exteriors Inc., Concord, ON (CA)

(21) Appl. No.: 16/962,216

(22) PCT Filed: Feb. 8, 2019
(86) PCT No.: PCT/US19/17228

§ 371 Date: Jul. 14, 2020

Related U.S. Application Data
(60) Provisional application No. 62/628,014, filed on Feb. 8, 2018.

(51) Int. Cl. C09D 7/40; C08J 7/04

(52) U.S. Cl. CPC C09D 7/70; C08K 3/042; C08J 7/042

(57) ABSTRACT

A primer containing graphene as an additive and a method of priming a filled polymer substrate for providing a Class A final paint surface. The method includes providing a substrate with reinforcement materials. A primer which includes from 0.5-5% by weight of graphene as an additive is applied to the substrate for coating the substrate. The primer is cured during heating of the resulting product for drying the substrate. The graphene acts to dissipate heat providing less differential of heat between the primer and the substrate and/or coatings applied on top of the primer which produces an improved final appearance of a paint over a fiber reinforced polymer material.

### CROSS-REFERENCE TO RELATED APPLICATIONS

This application claims the benefit of U.S. Provisional Application No. 62/628,014, filed Feb. 8, 2018. The disclosure of the above application is incorporated herein by reference.

### FIELD OF THE INVENTION

The present invention relates to a primer coating for fiber filled polymer substrate used in an exterior show surface of a vehicle.

### BACKGROUND OF THE INVENTION

Fiber filled thermoformed compositions are increasingly more common in manufacture of vehicle body panels, lift gates, hoods, and other vehicle parts. In many cases these parts are lighter than their steel counter parts and therefore offer a weight advantage. Often fiber filled substrates are manufactured as structural back panels or sub frames and it is necessary to provide an outer paintable Class A show surface over the underlying fiber filled structural substrate because the presence of filler fibers makes it difficult to create a class A show surface on the part. In order to address the problems with creating a show surface on fiber filled substrates, one solution involves covering and bonding an outer show surface skin to the structural fiber substrate. These processes have required extra time and additional steps to bond of the two pieces together.

It is believed that manufacturing labor and other costs can be saved if it were possible to provide a paint and process for allowing painting and forming a Class A surface on a finished part where the part includes an exterior show surface of a vehicle. Past attempts to paint a class A show surface onto the fiber filled substrate, however, these surfaces have not been found suitable for painting and forming a Class A exterior surface of a vehicle. In particular painting part with a filled polymer substrate using conventional coating (primer materials) did had a short wave (Sw), which is visible described as a poor, hazy appearance not suitable for a Class A show surface of a vehicle. To get an acceptable surface, additional work needs to be done to the surfaces, which may include extra steps such as finessing the surface or multiple pass through primer system. Other work arounds include refinishing the surface by buffing or provide increased primer thicknesses in an attempt to hide the filled surface. It has been found that the Sw issue occurs because of differential cooling in the polymer surface, which in turn affects the paint curing.

It is therefore desirable to provide a painting system for a filled polymer substrate that allows a Class A show surface on the final part by providing a paint system that can resolve issues with one pass and/or with no need to finesse the surface. Addition of graphene in primer layer will prevent adverse effects of differential cooling on the painted surface which occurs in fiber filled substrates. More specifically is desirable to provide graphene in the primer layer at a sufficient percentage and thickness to help dissipate the heat evenly and create uniform cooling conditions.

### SUMMARY OF THE INVENTION

In accordance with the present invention there is provided a primer for coating a filled polymer substrate. The primer includes graphene that is present in about 0.5% to about 5% by weight of the primer for attaching to a filled polymer substrate.

The present invention also related to a method of producing a Class A finish surface on a filled polymer substrate. The first step includes providing a filled polymer substrate. The fiber reinforcements are preferably carbon fibers of varying lengths and diameters, however, it is within the scope of this invention for the fiber reinforcements to be made of other materials including glass, aramid fibers or other suitable materials. The next step involves applying a primer to form a primer layer on the filled polymer substrate. The primer includes from about 0.5% to about 6% graphene calculated as a weight percentage of the primer. The primer is applied so that the primer layer has a thickness of a range selected between about 25 microns to about 100 microns. During additional steps, finish layers are applied over the primer layer, such layers include a base coat layer that is typically a paint layer and a top coat layer that is usually a clear coat layer. Next during a final step includes heating the filled polymer substrate and primer layer to dry the primer layer on the filled polymer substrate, wherein the graphene acts to dissipate heat providing less differential of heat between the primer layer and the filled polymer substrate to allow coatings, such as the base coat and top coat applied over the primer layer to dry with a Class A finish surface.

In accordance with the present invention a thermally dissipating primer coating is provided. It is believed that addition of graphene reinforcement to primer helps dissipate the heat evenly and create uniform cooling conditions. This is particularly useful in polymer coating structures in which glass fiber or other fillers or reinforcements are use in thermoplastic polypropylenes or other injection moldable or formable materials which are used in forming a Class A outer show surface of a vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an illustration of a current paint system on an unfilled substrate for comparison with the present invention;

FIG. 2 is an illustration of using a current paint system when used in a low or high bake system showing the problems with a filled polymer substrate material;

FIG. 2A is a magnified illustration view of heat acting on the filled polymer substrate layer;

FIG. 3 is an illustration of the advantages of the paint system of the present invention using a thermal dispersing primer including a graphene additive;

FIG. 3A is a magnified illustration view of heat acting on the filled polymer substrate layer;

FIG. 4 is a graphical illustration of Sw performance using the graphene filled polymers of the present invention;

FIG. 5 is a graph of the Sw results for the samples prepared according to the EXAMPLES below; and

FIG. 6 is a flow diagram showing a method of producing a Class A show surface on a filled substrate.

### DETAILED DESCRIPTION OF THE PREFERRED EMBODIMENTS

The following description of the preferred embodiment(s) is merely exemplary in nature and is in no way intended to limit the invention, its application, or uses.

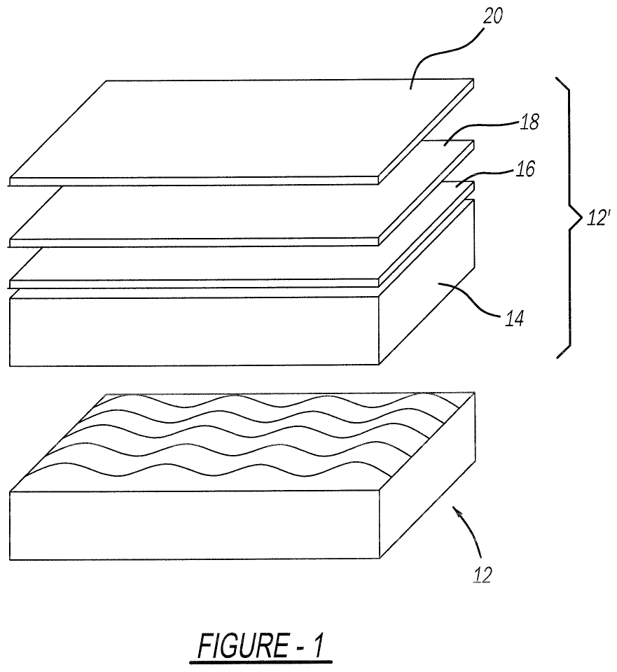

FIG. 1 schematically depicts a current paint system 10 for producing a finished part 12, 12′, schematically shown to be a portion of a polymeric vehicle body part that has a Class A show surface. Above the finished part 12, the different layers are schematically shown in an exploded view of the finished part 12′. The finished part 12′ shows an unfilled thermoplastic olefin (TPO) substrate 14 that has no reinforcement fillers. The current paint system 10 includes applying a primer layer 16, followed by a base layer 18, which is typically a paint layer to provide color to the finished part 12. Then a top layer 20 is applied, that is usually a clear coat layer. Then the finished part is dried to create the finished part 12. The finished part 12 meets the requirements for a Class A show surface.

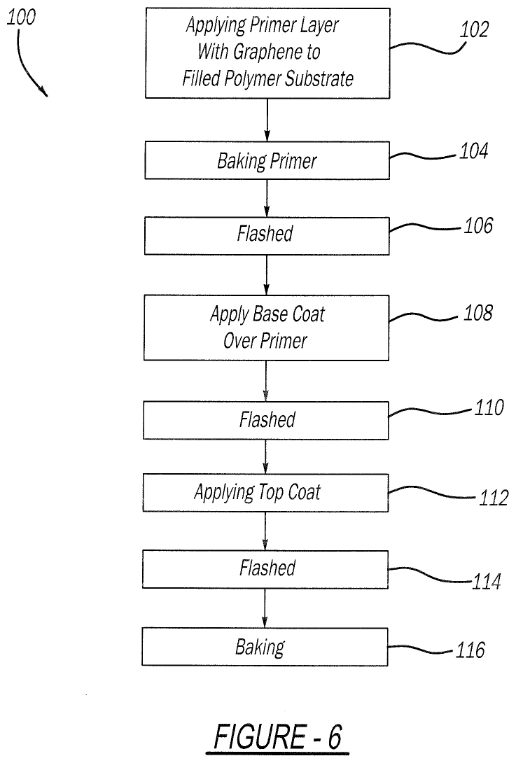

The current paint system 10 described in FIG. 1 is acceptable for used with unfilled TPO substrates, but as discussed herein does not provide an acceptable Class A show surface when applied to a filled substrate. FIG. 6 shows a flow diagram that outlines a method 100 for producing a Class A finish surface on a filled polymer substrate which will now be described. The method 100 is used to produce small batch testing samples as described in the Examples section below and can also be used in production to produce automotive exterior components that require a Class A finish surface. The method 100 involves providing a filled polymer substrate that at a step 102 a primer containing graphene is applied to the surface of the filled polymer substrate to form a primer layer. At a step 104 the filled polymer substrate with the primer layer applied is baked at an elevated temperature ranging from between about 49° C. to about 121° C. generally and preferably at a temperature equal to or greater than 80° C. for a suitable period of time, which will depend on the size of the part or sample. At a step 106 the filled polymer substrate with the primer layer is flashed at ambient temperature for a period of time, which will depend on the size of the part of sample. Next at step 108 a base coat is applied over the primer layer. The base coat is a color layer and can include paint or paint film. Next at step 110 the base coat on the primer layer disposed over the filled polymer substrate is flashed at ambient temperature for a period of time, which will depend on the size of the part of sample. At step 112 a top coat is applied over the base coat and then at step 114 the top coat over the base coat, primer layer and filled polymer substrate is flashed at ambient temperature for a period of time, which will depend on the size of the part of sample. At step 116 the top coat with base coat, primer layer and filled polymer substrate is baked at an elevated temperature ranging from between about 49° C. to about 121° C. generally and preferably at a temperature equal to or greater than 80° C. for a suitable period of time, which will depend on the size of the part or sample. At the completion of step 116 the part of sample is now completed.

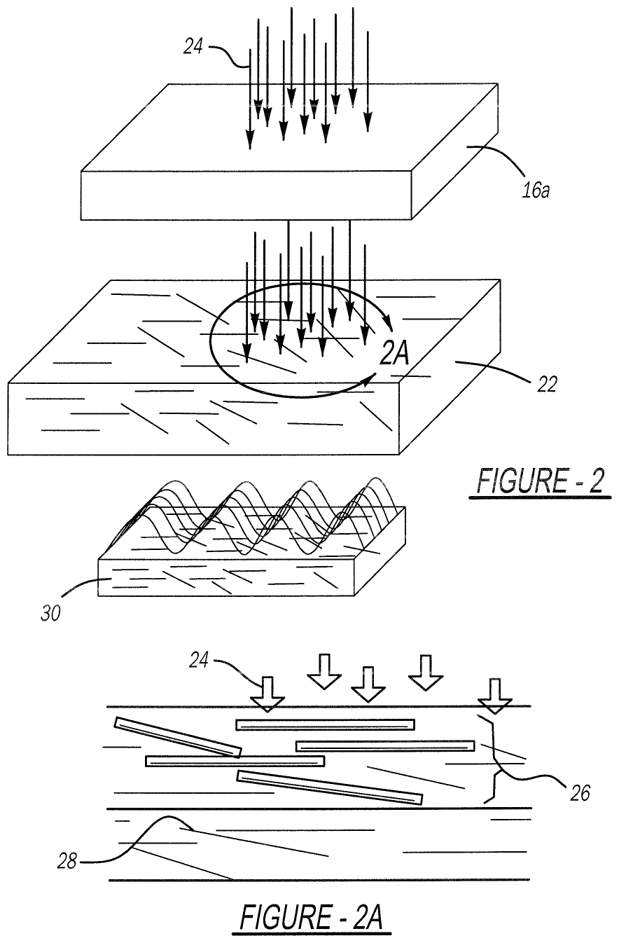

Referring now to FIG. 2, there is a schematic representation of what happens when a filled polymer substrate 22 having a primer layer 16a formed from a primer that has no graphene, like the primer of FIG. 1, is used in the method 100 described above. When the primer layer 16a is applied to the filled thermoplastic substrate 22, it does not change the thermal characteristics of the filled thermoplastic substrate 22 and the filler material in the substrate causes unfavorable collection of heat at the fibers. Referring also to FIG. 2A, an enlarged schematic view of the filled thermoplastic polymer substrate 22 is shown. After the primer layer 16a is applied heat 24, which can be heat applied during subsequent baking steps 104, 116 in the method of FIG. 6, is applied and causes heat 24 to collect around fibers 26 dispersed in a substrate 28 of the filled thermoplastic polymer substrate 22. The way the heat collects around the fibers 26 changes the thermal characteristics of a finished part resulting in high shortwave (Sw) and longwave (Lw) light testing qualities, which are undesirable and do not provide a Class A finish. The difference in thermal characteristics are due to the presence of the fibers in the substrate, but could be counteracted by the primer layer. However, standard primers, such as the primer layer 16a have no method to dissipate heat which creates aberrations in the final coated surface during heat curing cycles. A finished surface 30 of a sample or part produced has a high long wave and short wave value that makes the finished surface 30 look wavy or hazy, which does not meet the standards required for a Class A finish surface.

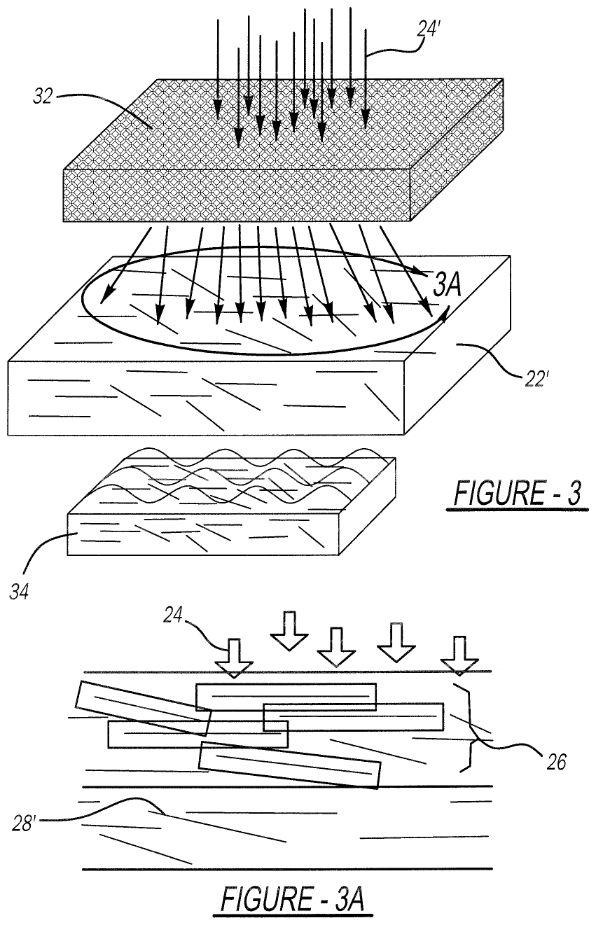

Referring now to FIG. 3 there is shown a schematic representation of what happens when a filled thermoplastic substrate 22′ has a primer layer 32 formed from a primer having graphene is applied during the step 102 in the method 100. When primer layer 32 is applied to the thermoplastic substrate 22′, it changes the thermal characteristics of the filled thermoplastic substrate 22′. Referring also to FIG. 3A, an enlarged schematic view of the filled thermoplastic polymer substrate 22′ is shown. After the primer layer 32 is applied heat 24′, which can be heat applied during the subsequent baking steps 104, 106 in the method 100 is applied. The heat 24′ collects around fibers 26′ of substrate 28′ of the filled thermoplastic polymer substrate 22′. The way the heat collects around the fibers 26′ is different than the way the heat collects around fibers 26 shown in FIG. 2A, when a primer without graphene is used. In FIG. 3A compared to FIG. 2A, the curing heat is dissipated and disperse through a combination of conduction through the graphene particles and convection through the polymer material for a superior final show surface coating.

A finished show surface 34 of a sample or part produced has low long wave and short wave values that makes the finished surface 34 look smooth and has a wet paint look that is characteristic of a Class A finished surface. Typically the finished show surface 34 has a Sw of 26 or less and preferably 15 or less. The primer layer 32 includes graphene as an additive. The primer includes generally from about 0.5-5% and preferably from about 1.5 to 3.0% by weight of graphene as an additive applied to the substrate for coating the substrate. The dissipation of heat is effected by the amount of graphene and also the thickness of the primer layer. The primer layer is generally between 20 microns to 70 microns. Other ideal thickness ranges include 40 microns to 60 microns and 20 microns to 30 microns preferably. In other applications the preferable thickness is about 50 microns. The thickness of the primer layer also effects the amount of graphene that is needed in the primer layer. Stated another way, if the primer layer is thicker a primer with a lower weight percentage of graphene can be used. However, the thickness of the primer layer and the weight percentage of the graphene might not always be correlated because other variables of a particular application might require a thicker primer and greater percentage of graphene. The use of graphene is found useful in heat cure paint systems resulting in a Class A show surface ideally on a filled polymer substrate.

In a preferred embodiment of the invention the polymer filled substrate is a thermoplastic matrix including polyamide or polypropylene. However, the present invention is also applicable to being used with acrylonitrile butadiene styrene (ABS), nylon, or polyolefin substrates. It is also within the scope of the invention for the polymer filled substrate to be a thermoset matrix of sheet molding compound. For both the thermoplastic matrix and thermoset matrix the types of fibers used as fillers in a preferred embodiment are carbon fibers, however, it is possible for other fibers to be used including, but not limited to glass fibers or aramid fibers. When carbon fibers are used they are generally 0.5 mm to 4.5 mm in length when mixed with the polymer. More specifically the fibers are less than or equal to 4 mm in length prior to mixing with the polymer and are then reduced during mixing to about 1.5 mm in length. If glass fibers are used they are generally about 3 mm to about 12 mm in length and are reduced to about 6 mm to about 1.5 mm in length after mixing with the polymer.

Regarding the primers used, typically paint primers having suitable additives for adhering to these substrates are mixed with the effective amounts of the graphene additive. In a preferred embodiment of the invention the primer is a solvent based multi-surface polyester resin primer with graphene added in the weight percentages discussed herein. However, other primers base materials include polyurethane and epoxy, which are used in OEM paint systems in the automotive industry. It is anticipated that the paint system will include a primer layer (containing graphene), a base (color) coat layer and a clear coat layer as is known in the art of vehicle exterior body painting. The base coat layer can take many forms, but include and are not limited to solvent based or water based base coats having melamine, polyester and acrylic. The top coat layer is usually a clear solvent based coating including but not limited to melamine, or polyester. Top coat layers also include clear coats used for paint on top of the primers herein include cross-linkable top coat paint systems such as polyurethane, polyester, melamine and acrylic resins cross-linkable to isocyanate and preferably monomeric urethane isocyanate resins.

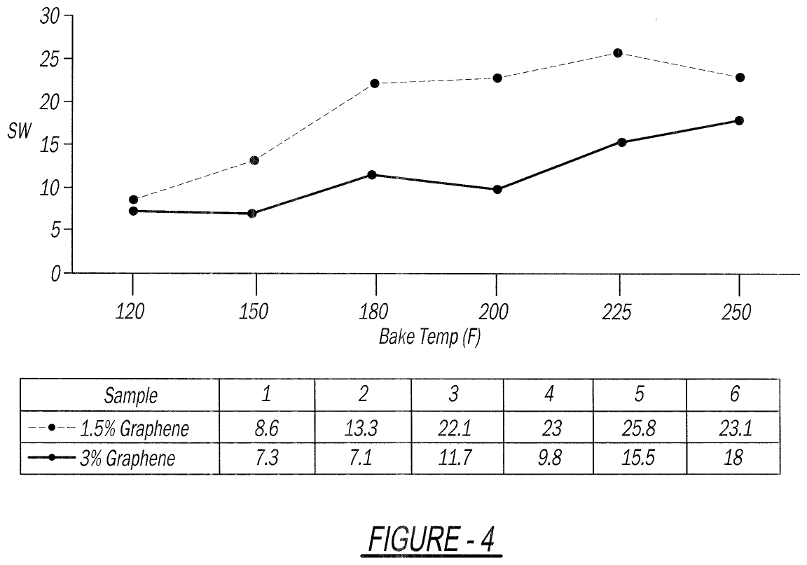

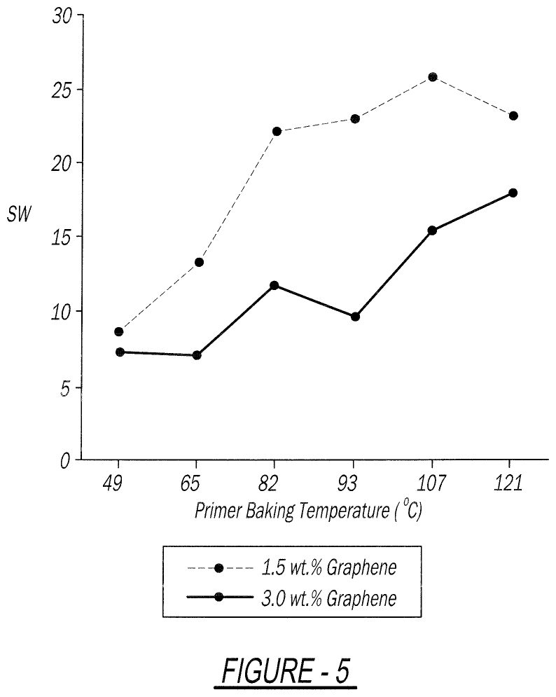

Referring to FIG. 4 there is shown the effect on 2K sealer appearance with 1.5% and 3% graphene in primers as it relates to bake temperature of 120-250 degrees Fahrenheit (from left to right on the graph). FIG. 5 shows the of 1.5% and 3% graphene by weight primer in comparison to a control primer (having no graphene). The graphene addition in amounts of 1.5 and 3% by weight is shown to provide improved coatings with lower Sw. The results demonstrate that the presence of graphene in greater weight percentages produce more favorable Sw, which is noticeable when comparing the samples containing 3% weight graphene to 1.5% weight graphene. The primers of the present invention are particularly advantageous in low temperature bake coating applications, but also show advantages in high temperature bake painting systems as well.

In working examples 0.5%, 1%, 1.5%, 2.5% 3.5%, 4%, 4.5% and 5% graphene are used in heat cured primers and tested at heating temperatures from “low bake” temperatures to “high bake” temperatures i.e. from about 120 to 250 degrees Fahrenheit and are found to provide show surface quality final painted surfaces over filled polymer substrates.

The substrates useful in the present invention typically include fiber filled polymer materials normally used as structural parts in vehicle body panel. One such material is a sheet molding composition substantially filled with between 0.5 mm and 4.5 mm fibers. Other materials in which the invention is useful include thermoplastic olefins substantially filled with chopped carbon fibers and molded into a final part which includes a Class A surface as a part of the final molded part molded out of the fiber filled material. Other chopped carbon fiber filled thermoset or thermoformed polymer parts will find the present invention advantageous. The primers of the present invention are also useful on carbon fiber filled materials.

### Examples

Set forth below are Tables 1-4 which set out the parameters used to prepare the samples. For each table a set of two samples were prepared using a primer with either 1.5% wt graphene or 3% wt graphene, totaling eight samples. The samples are prepared according to the steps of the method of producing samples 100 described above and shown in FIG. 6. The samples all have a polymer filled substrate, which in the samples formed according to Tables 1-4 is a polyamide resin with 20% carbon fibers dispersed evenly through the polyamide resin. The carbon fibers added prior to mixing were short fibers being less than or equal to 4 mm in length and were reduced to an average fiber length of about 1.5 mm after mixing with the polyamide resin.

Next primer was applied to the filled substrate so that the sample had a primer thickness layer of about 50 microns. The primer is a two component solvent solution containing either 1.5% wt graphene or 3% wt graphene. Once the primer was applied each pair of samples was baked for 20 minutes at different temperatures ranging from 49° C. to 121° C., as set out in each table. The temperature of the primer baking conditions is the variable between each set of primer samples in the tables.

After baking the primer onto the substrate the samples were flashed for 10 minutes at room temperature and then, all of the samples were then coated with a silver color base coat layer that was 20 microns thick. The samples with the base coat layer where then flashed at room temperature for 10 minutes. Next a top coat layer (i.e., clear coat layer) was applied over the base coat layer. The top coat layer was 37 microns thick. The samples were then flashed for 10 minutes at room temperature. Then all of the samples underwent a final baking step where they were baked for 30 minutes at 82° C.

TABLE 1

| Substrate: | 20CF-PA6 | | |
|---|---|---|---|
| Substrate: | 20CF-PA6 | | |
| Primer: | 50 microns | | |
| Primer baking | 49° C. × 20 min | | |
| conditions: | | | |
| Flashing: | 10 min at room temperature | | |
| Base coat: | 20 microns (silver) | | |
| Flashing: | 10 min at room temperature | | |
| Clear coat: | 37 microns | | |
| Flashing: | 10 min at room temperature | | |
| Final baking | 82° C. × 30 min | | |
| conditions: | | | |
| Visual Analysis | Graphene wt. %: | 1.5 | 3.0 |
| | Orange Peel: | 9.6 | 10.2 |
| | DOI: | 90.6 | 90.6 |
| | LW: | 2.7 | 2 |
| | SW: | 8.6 | 7.3 |

TABLE 2

| Substrate: | 20CF-PA6 | | |
|---|---|---|---|
| Primer: | 50 microns | | |
| Primer baking | 65° C. × 20 min | | |
| conditions: | | | |
| Flashing: | 10 min at room temperature | | |
| Base coat: | 20 microns (silver) | | |
| Flashing: | 10 min at room temperature | | |
| Clear coat: | 37 microns | | |
| Flashing: | 10 min at room temperature | | |
| Final baking | 82° C. × 30 min | | |
| conditions: | | | |
| Visual Analysis | Graphene wt. %: | 1.5 | 3.0 |
| | Orange Peel: | 8.9 | 9.6 |
| | DOI: | 89.8 | 91 |
| | Lw: | 3.7 | 3.1 |
| | Sw: | 13.3 | 7.1 |

TABLE 3

| Substrate: | 20CF-PA6 | | |
|---|---|---|---|
| Primer: | 50 microns | | |
| Primer baking | 82° C. × 20 min | | |
| conditions: | | | |
| Flashing: | 10 min at room temperature | | |
| Base coat: | 20 microns (silver) | | |
| Flashing: | 10 min at room temperature | | |
| Clear coat: | 37 microns | | |
| Flashing: | 10 min at room temperature | | |
| Final baking | 82° C. × 30 min | | |
| conditions: | | | |
| Visual Analysis | Graphene wt. %: | 1.5 | 3.0 |
| | Orange Peel: | 8.1 | 9.4 |
| | DOI: | 86.8 | 89.1 |
| | Lw: | 5.4 | 3 |
| | Sw: | 22.1 | 11.7 |

TABLE 4

| Substrate: | 20CF-PA6 | | |
|---|---|---|---|
| Primer: | 50 microns | | |
| Primer baking | 93° C. × 20 min | | |
| conditions: | | | |
| Flashing: | 10 min at room temperature | | |
| Base coat: | 20 microns (silver) | | |
| Flashing: | 10 min at room temperature | | |
| Clear coat: | 37 microns | | |
| Flashing: | 10 min at room temperature | | |
| Final baking | 82° C. × 30 min | | |
| conditions: | | | |
| Visual Analysis | Graphene wt. %: | 1.5 | 3.0 |
| | Orange Peel: | 7.8 | 9.7 |
| | DOI: | 86.3 | 86 |
| | Lw: | 6.2 | 2.6 |
| | Sw: | 23 | 9.8 |

The above samples were then tested to assess their shortwave, longwave, DOI and Orange Peel properties, the results of which are reported in the visual analysis section of the tables above. FIG. 5 is a graph showing the results of the shortwave property measurements for all twelve of the samples. When interpreting the results shown on the graph, the lower the shortwave measurement the better in terms of providing a suitable Class A surface. As shown in FIG. 5 the samples containing 3.0% wt graphene primer provided the best Sw measurements. In terms of temperature variances during the primer baking step, the lower temperature samples that were 49° C. and 65° C. had the best Sw readings. However, in most production applications the oven temperatures will be between preferably 75° C. to 100° C. The samples with 3.0% wt graphene primer had an ideal Sw reading of 11.7 at 82° C. and lowered to 9.8 at 95° C.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A method of producing a Class A finish surface on a filled polymer substrate comprising:
A. Providing a filled polymer substrate;
B. Applying a primer to form a primer layer on the filled polymer substrate, which includes from 0.5 to 6% graphene, and
C. Heating the filled polymer substrate and primer layer to dry the primer layer on the filled polymer substrate, wherein the graphene of the primer layer acts to dissipate heat providing less differential of heat between the primer layer and the filled polymer substrate to allow finish coatings applied over the primer layer to have a Class A finish surface.

2. The method of claim 1 wherein the filled polymer substrate is a thermoplastic matrix having reinforcing fibers and a thermoplastic polymer that is one selected from the group consisting essentially of polyamide, polypropylene, thermoplastic olefin and acrylonitrile butadiene styrene.

3. The method of claim 2 wherein the reinforcing fibers are one selected from the group consisting essentially of carbon, glass, aramid and combinations thereof.

4. The method of claim 1 wherein the filled polymer substrate is a thermoset matrix having reinforcing fibers

5. The method of claim 4 wherein the thermoset matrix is a sheet molding compound and the reinforcing fibers are one selected from the group consisting essentially of carbon, glass, aramid and combinations thereof.

6. The method of claim 1 wherein the shortwave (Sw) measurement of the Class A finish surface is less than or equal to about 26.

7. The method of claim 1 wherein the polymer substrate with fibers reinforcements is a sheet molding composition substantially filled with fiber reinforcements that are in a range of about 1 inch to about 3 inches in length.

8. The method of claim 1 wherein the graphene is provided in the primer layer in an amount of from about 1% to about 4% by weight of the primer.

9. The method of claim 1 wherein the graphene is provided in the primer layer in an amount of from about 1.5% to about 3% by weight of the primer.

10. The method of claim 1 wherein the Sw of the Class A finish surface is less than or equal to about 15.

11. The method of claim 1 wherein the primer layer has a primer base material that is either an epoxy, polyester or urethane.

12. A primer for coating a filled polymer substrate comprising graphene present from about 0.5% to about 5% by weight of the primer for attaching to a filled polymer substrate.

13. The primer of claim 12 wherein said graphene is used in amounts of from about 1.0% to about 4% by weight in the primer material.

14. The primer of claim 12 wherein the graphene is used in amounts of from about 1.5% to about 3.5% by weight in said primer material.

15. The primer of claim 12 wherein the filled polymer substrate is filled polyolefin with carbon fiber reinforcements.

16. The primer of claim 12 wherein the fiber reinforcements of the filled polymer substrate with fibers reinforcements is polyamide with carbon fiber reinforcements.

17. The primer of claim 16 wherein said primer is a polyester, urethane or epoxy based system.

18. The primer of claim 12 wherein the filled polymer substrate is a thermoplastic matrix having reinforcing fibers and a thermoplastic polymer that is one selected from the group consisting essentially of polyamide, polypropylene, thermoplastic olefin and acrylonitrile butadiene styrene.

19. The primer of claim 18 wherein the reinforcing fibers are one selected from the group consisting essentially of carbon, glass, aramid and combinations thereof.

20. The primer of claim 12 wherein the filled polymer substrate is a thermoset matrix having reinforcing fibers

21. The primer of claim 20 wherein the thermoset matrix is a sheet molding compound and the reinforcing fibers are one selected from the group consisting essentially of carbon, glass, aramid and combinations thereof.

22. A method of producing a Class A finish surface on a filled polymer substrate comprising:
A. Providing a filled polymer substrate;
B. Applying a primer to form a primer layer on the filled polymer substrate, which includes from about 0.5% to about 6% graphene calculated as a weight percentage of the primer, wherein the primer layer has a thickness of a range selected between about 25 microns to about 100 microns, and
C. Heating the filled polymer substrate and primer layer to dry the primer layer on the filled polymer substrate, wherein the graphene acts to dissipate heat providing less differential of heat between the primer layer and the filled polymer substrate to allow coatings applied over the primer layer to have a Class A finish surface.

23. The method of claim 22 wherein the filled polymer substrate is a thermoplastic matrix having reinforcing fibers and a thermoplastic polymer that is one selected from the group consisting essentially of polyamide, polypropylene, thermoplastic olefin and acrylonitrile butadiene styrene.

24. The method of claim 23 wherein the reinforcing fibers are one selected from the group consisting essentially of carbon, glass, aramid and combinations thereof.

25. The method of claim 22 wherein the filled polymer substrate is a thermoset matrix having reinforcing fibers

26. The method of claim 25 wherein the thermoset matrix is a sheet molding compound and the reinforcing fibers are one selected from the group consisting essentially of carbon, glass, aramid and combinations thereof.

27. The method of claim 22 wherein the shortwave (Sw) measurement of the Class A finish surface is less than or equal to about 26.

28. The method of claim 22 wherein the polymer substrate with fibers reinforcements is a sheet molding composition substantially filled with fiber reinforcements that are in a range of about 1 inch to about 3 inches in length.

29. The method of claim 22 wherein the graphene is provided in the primer layer in an amount of from about 1% to about 4% by weight of the primer.

30. The method of claim 22 wherein the graphene is provided in the primer layer in an amount of from about 1.5% to about 3% by weight of the primer.

31. The method of claim 22 wherein the Sw of the Class A finish surface is less than or equal to about 15.

32. The method of claim 22 wherein the primer layer is either an epoxy, polyester or urethane based primer.
